(19) United States
(12) Patent Application Publication
(10) Pub. No.: US 2005/0239019 A1
(43) Pub. Date: Oct. 27, 2005

(54) Method of applying an antiseptic to an oral appliance

(76) Inventor: Teena V. Hall, Crimora, VA (US)

Correspondence Address: Richard C. Litman;LITMAN LAW OFFICES, LTD., P. O. Box 15035, Arlington, VA, 22215, US

(21) Appl. No.: 10/828,338

(22) Filed: Apr. 21, 2004

(51) Int. Cl. A61C 1/00

(52) U.S. Cl. 433/229; 433/167

(57) ABSTRACT

The method of applying an antiseptic to an oral appliance employs a spray-type dispenser to apply an oral antiseptic to cleanse and refresh oral equipment, such as retainers, partials, dentures, mouthpieces, or clear braces. The method involves applying the antiseptic to the appliance outside the mouth in settings unsuited for brushing or otherwise cleansing and refreshing the equipment, such as at work, at school or on a playfield. The dispenser is intended to be easily transportable and disposable, containing sufficient antiseptic for a single use. The antiseptic contained with the dispenser can be made in different colors and flavors. A user removes the oral appliance from the mouth, sprays the antiseptic directly on the appliance, and replaces the equipment within the mouth for continued use.

### BACKGROUND OF THE INVENTION

1. Field of the Invention

The present invention relates to oral hygiene, and more particularly to a method of applying an oral antiseptic to an oral appliance using a spray dispenser.

2. Description of the Related Art

Maintaining good oral hygiene by brushing teeth or using personal oral care items, such as mouthwash, is important in keeping the mouth free of germs and odor. Mouthwash is useful when individuals are unable to brush due to their activities, or due to lack of the proper tools to clean the teeth, for example, a toothbrush. On the other hand, an antiseptic that can be used outside of the mouth but which is also safe when ingested orally is especially useful for individuals who use oral or orthodontic appliances that can be removed from the mouth, such as retainers, partials, dentures or mouthpieces. Mouthwashes, however, are not so easily used for this purpose, since they are usually dispensed in big bottles and must be parsed out into smaller quantities before use, so that the mouthwash is difficult to apply efficiently to oral equipment outside the mouth and often spills. It becomes difficult and awkward to cleanse and refresh and maintain oral hygiene for one's oral equipment in such settings as school, work, or on a game field. There is a need for an oral antiseptic that can be dispensed directly on oral equipment, outside of the mouth, in an easily transportable container that can be disposed of after use, so that proper oral hygiene can be maintained between regular cleaning.

European Patent Number 1,013,261, published on Jun. 28, 2000, discloses a composition of mouth spray with tea polyphenols as the active ingredient and a mouth sprayer for spraying the mouth spray within the mouth by a small pump type or squeezable container. Japanese Patent Number 11,165,778 published on Jun. 22, 1999, discloses a manual spray container filled with mouthwash to be dispensed from a nozzle of the container. The mouthwash is sprayed into water in a glass and the diluted water is kept in the mouth to wash the mouth.

Many devices have been developed to dispense a liquid directly within the mouth. U.S. Pat. No. 1,868,893, issued to Gentle on Jul. 26, 1932, discloses a small portable massage and spray apparatus for treating the mouth, nose or throat. The device comprises a motorized air compressor that is joined to a container and a mixer with a variety of nozzles or nipples for dispensing a liquid spray. The nipples are formed of rubber and are meant to be pliable in order to massage the mouth. U.S. Pat. No. 4,457,711, issued to Maloney et al. on Jul. 3, 1984, discloses a pressurized bottle of oral solution having a separate, cup-shaped scrubbing member to scrub the gums and the teeth.

Some devices have tips to direct a liquid into a particular area within the mouth. U.S. Pat. No. 3,480,009, issued to Sinai on Nov. 25, 1969, discloses a handheld oral hygiene appliance. The appliance dispenses a fluid by a pressure pump. A massage pick is disposed at the end of the pump and is in fluid communication with the pump discharge.

U.S. Pat. No. 5,558,518, issued on Sep. 24, 1996, and U.S. Pat. No. 5,755,572, issued May 26, 1998, both to Bab et al., disclose an oral hygiene irrigator syringe bulb. The syringe bulb is made of compressible elastic to hold a fluid. An irrigation tip is attached to the opening of the bulb to dispense the fluid within the bulb into the mouth. The irrigation tip is shown as being curved, slightly curved or straight.

U.S. Pat. No. 6,669,475, issued to Kandelman et al. on Dec. 30, 2003, discloses a device suited for cleaning the interproximal dental surface by a needle. A drug is stored within a reservoir of the device to be dispensed by the needle. The needle is made in a variety of forms.

Another device or system for cleaning the mouth is disclosed in U.S. Pat. No. 5,082,444, issued to Rhoades et al. on Jan. 21, 1992, which describes a portable, self-powered, oral cavity cleaner that produces a pulsed stream of fluid to clean the teeth and gums. The device is a self-contained pressurized unit that can be transferred from one container to another. The fluid is dispensed by compressed gas contained within the container.

U.S. Pat. No. 6,561,803, issued to Rizoiu et al. on May 13, 2003, discloses a fluid conditioning system for introducing conditioned fluids into the cutting, irrigating, evacuating, cleaning and drilling techniques used in dental medicine.

Compositions for mouthwash or dental compositions are disclosed in U.S. Pat. No. 4,689,214, issued to Niles et al. on Aug. 25, 1987; U.S. Pat. No. 5,723,106, issued to Buch et al. on Mar. 3, 1998; U.S. Pat. No. 6,565,832, issued to Haslwanter et al. on May 20, 2003; and U.S. Pat. No. 6,610,276, issued to Melman on Aug. 26, 2003.

None of the above inventions and patents, taken either singly or in combination, is seen to describe the instant invention as claimed. Thus, an oral antiseptic in a spray dispenser solving the aforementioned problems is desired.

### SUMMARY OF THE INVENTION

The method of applying an antiseptic to an oral appliance employs a spray-type dispenser to apply an oral antiseptic to cleanse and refresh oral equipment, such as retainers, partials, dentures, mouthpieces, or clear braces. The method involves applying the antiseptic to the appliance outside the mouth in settings unsuited for brushing or otherwise cleansing and refreshing the equipment, such as at work, at school or on a playfield. The dispenser is intended to be easily transportable and disposable, preferably holding at least one ounce of oral antiseptic. The antiseptic contained with the dispenser can be made in different colors and flavors. A user removes the oral appliance from the mouth, sprays the antiseptic directly on the appliance, and replaces the equipment within the mouth for continued use.

These and other features of the present invention will be readily apparent upon consideration of the following specification and drawings.

### BRIEF DESCRIPTION OF THE DRAWINGS

FIG. 1 is an environmental, perspective view of a user dispensing oral antiseptic from a spray dispenser onto a denture according to the method of the present invention.

FIG. 2 is a front view of an exemplary spray dispenser that can be used to practice the method of the present invention.

Similar reference characters denote corresponding features consistently throughout the attached drawings.

### DETAILED DESCRIPTION OF THE PREFERRED EMBODIMENT

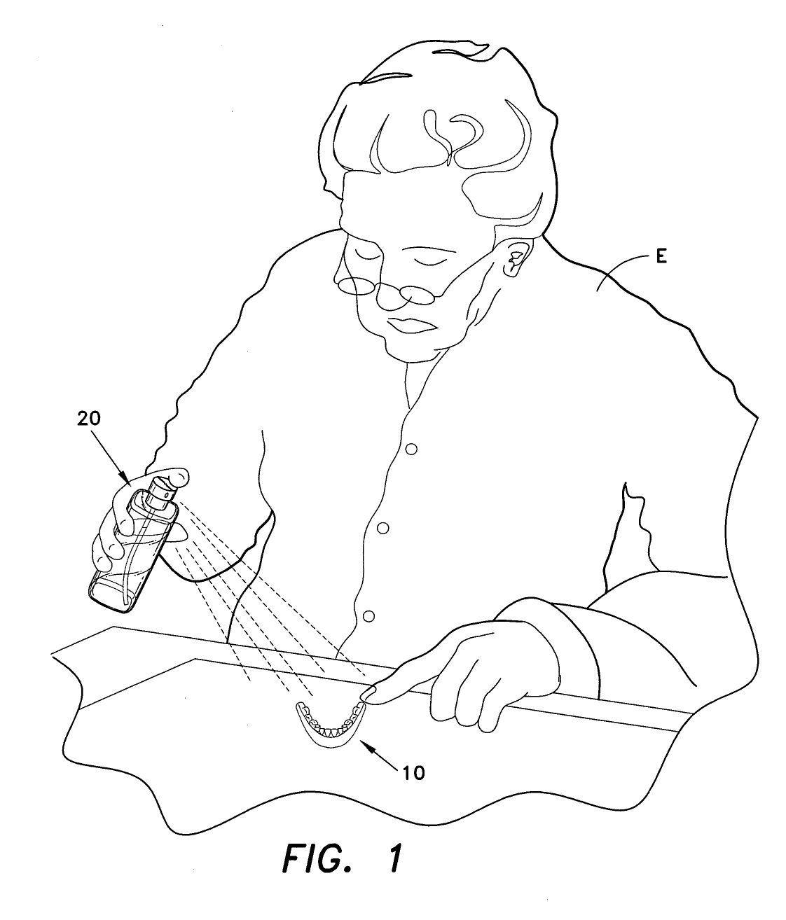

The present invention is a method of applying an antiseptic to an oral appliance. As shown in FIG. 1, a user holds an oral appliance, such as dentures 10, outside the mouth and sprays antiseptic from a spray dispenser 20 directly on the denture 10. Although a denture 10 is shown in FIG. 1, it will be understood that the method of the present invention may be used to apply antiseptic to any oral or orthodontic appliance that is removable from the mouth, including dentures (full or partial), retainers, mouthpieces used to protect the teeth while playing sports, clear braces, etc. Once the oral appliance is sprayed, the user E can replace the denture 10 or other appliance in the mouth. The method requires that the oral appliance held in the hand or otherwise be situated outside the mouth or already removed from the mouth in order to spray the antiseptic from the dispenser 20.

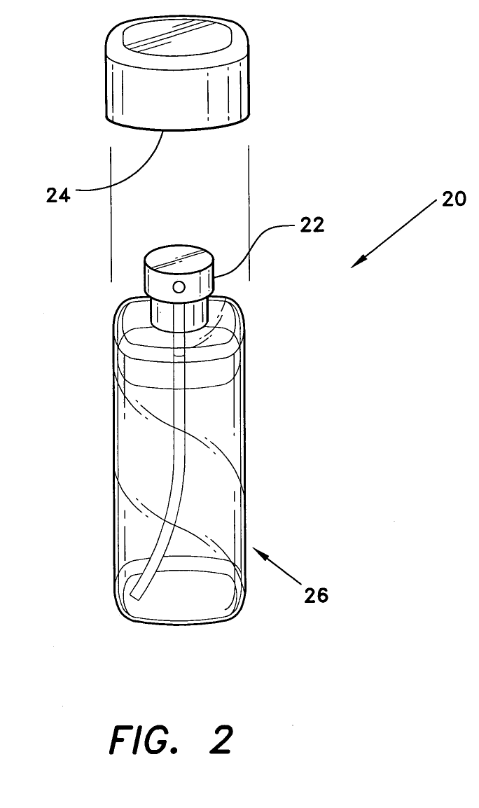

As shown in FIG. 2, preferably the dispenser 20 has a pump spray nozzle 22 disposed under a removable lid 24. The lid 24 is removed and the nozzle 22 is depressed to eject the antiseptic retained within the body 26 of the dispenser 20. The dispenser 20 is designed for easy transport being small enough to be carried in a woman's purse, a child's bookbag or a pocket. The dispenser 20 would preferably be three inches tall and one inch wide and hold one ounce of antiseptic for single use. However, the size of the dispenser 20 can be larger to hold more than one ounce and yet still be easily portable. The dispenser 20 is preferably disposable, so that the dispenser 20 is not refillable, but is disposed of after the antiseptic is exhausted. The antiseptic may be any composition having antibacterial or antimicrobial activity that is safe for oral use. The antiseptic may be a mouthwash, e.g., Listerine® (Listerine is a trademark of the Warner-Lambert Company of New Jersey) The antiseptic disposed in the body 26 can be any flavor or combination of flavors, and can be any color.

The user would use the dispenser 20 in any setting, but the method is particularly useful in settings or situations where it is difficult to brush or otherwise cleanse and refresh the oral appliance, such as during work, at school or on a game field. Athletes, such as football players, would find the dispenser 20 useful in cleansing and refreshing oral protectors, such as mouthpieces that are attached to a football helmet. Oftentimes, football players who are off the field remove the helmet from their head and place it on the ground or a bench and without realizing, the mouth guard becomes unclean. Again, as described above, the football player would spray the antiseptic from the dispenser 20 onto the mouthpiece and place the mouthpiece back in the mouth.

It is to be understood that the present invention is not limited to the embodiment described above, but encompasses any and all embodiments within the scope of the following claims.

1. A method of applying antiseptic to an oral appliance, comprising the steps of:
providing a liquid antiseptic in a spray dispenser;
holding the oral appliance; and
spraying the antiseptic on the oral appliance;
whereby the antiseptic is applied to the oral appliance outside of a user's mouth.

2. The method of applying antiseptic according to claim 1, wherein the spray dispenser is a single use disposable container, the method further comprising the step of disposing of the spray dispenser when the antiseptic is exhausted.

3. The method of applying antiseptic according to claim 1, wherein the antiseptic comprises mouthwash.

4. The method of applying antiseptic according to claim 1, wherein the spray dispenser comprises a pump sprayer.

5. The method of applying antiseptic according to claim 1, further comprising the step of removing the oral appliance from the user's mouth prior to spraying the oral appliance.

6. The method of applying antiseptic according to claim 1, further comprising the step of inserting the oral appliance into the user's mouth after spraying the oral appliance.

7. The method of applying antiseptic according to claim 1, wherein the oral appliance is selected from the group consisting of a denture, a retainer, a mouthpiece, and braces.

8. A portable, disposable, oral antiseptic spray dispenser, comprising:
a container made from a disposable material;
a pump sprayer having a nozzle, the pump sprayer being disposed in the container;
a removable cap attached to the container and disposed over the nozzle;
a liquid antiseptic disposed in the container adapted for cleaning an oral appliance, the antiseptic having a volume dimensioned for a single application to the oral appliance; whereby a user cleans the oral appliance and disposes of the container.
